(19) United States
(12) Patent Application Publication
(10) Pub. No.: US 2024/0011341 A1
(43) Pub. Date: Jan. 11, 2024

(54) MULTI-USE DOOR DEVICE

(71) Applicant: Oolie Inc., Portland, OR (US)

(72) Inventor: Nora Murray, Portland, OR (US)

(21) Appl. No.: 17/859,096

(22) Filed: Jul. 7, 2022

(51) Int. Cl. E05C 19/18

(52) U.S. Cl. CPC E05C 19/182; E05C 19/184

(57) ABSTRACT

A device includes a base and a bumper. When the base is attached to a door at a first orientation, the device has a noise dampening configuration in which (i) the base is disposed between the face plate of the door and a door frame strike plate when the door is at a closed position and (ii) the bumper is offset from the face plate of the door and the door frame strike plate when the door is at the closed position. And, when the base is attached to the door at a second orientation, the device has a safety configuration in which (i) the bumper is disposed between the door and a door frame as the door is moved toward the closed position, and (ii) the base is offset from the door frame strike plate when the bumper is disposed between the door and the door frame.

### TECHNICAL FIELD

This disclosure generally relates to multi-use door devices, systems, and methods. Certain such embodiments are described herein in the context of a multi-use door device that is configured to be interchangeably attached to a door in one of a noise dampening configuration and a safety configuration. In such embodiments, the same multi-use door device can be configured for interchangeable use in one configuration—the noise dampening configuration—that reduces or eliminates noise generated as a result of closing a door and another configuration—the safety configuration—that reduces or eliminates instances of an object, such as a finger, getting caught between a door and a frame when the door is being closed.

### BACKGROUND

In a typical household, a single door may be opened and closed routinely throughout a day. In households with young children and/or residents sensitive to loud noises, closing a door, while inevitably necessary, can have undesired results. For instance, closing a door can create undesirable noise, both in instances where a door is slammed shut (e.g., by a young child) and even in instances where a door is slowly closed due to the door's latch engaging the door frame's strike plate. Closing a door can also create a safety risk of an object, such as one or more fingers, getting caught between the door and the door frame, particularly when the door is quickly shut. Accordingly, the routine act of closing a door can have undesired results, including creating noise that may wake a resident in the household and/or causing unintended injury.

### SUMMARY

In general, various embodiments relating to multi-use door devices, systems, and methods are disclosed herein. In particular, embodiments disclosed herein can provide a single device that can be installed in at least two different configurations with each such different installation configuration able to provide a different beneficial function associated with closing a door. For example, embodiments disclosed herein include a multi-use door device that is configured to be interchangeably attached to a door in one of a noise dampening configuration and a safety configuration. In such embodiments, the same multi-use door device can be configured for interchangeable use in one configuration—the noise dampening configuration—that reduces or eliminates noise generated as a result of closing a door and another configuration—the safety configuration—that reduces or eliminates instances of an object, such as a finger, getting caught between a door and a frame when the door is being closed. Accordingly, such embodiments can facilitate manufacturing efficiencies because the same device can serve multiple, different functions depending on the configuration in which that device in attached to a door, and, moreover such embodiments can allow a user, when so desired, to change the configuration of the device to provide a different benefit.

One embodiment includes a device. This device includes a base and a bumper. The base includes a door face plate fixation structure. The bumper extends out from the base. When the base is attached to a face plate of a door at a first orientation via the door face plate fixation structure, the device has a noise dampening configuration in which (i) the base is disposed between the face plate of the door and a door frame strike plate when the door is at a closed position and (ii) the bumper is offset from the face plate of the door and the door frame strike plate when the door is at the closed position. And, when the base is attached to the face plate of the door at a second orientation via the door face plate fixation structure, the device has a safety configuration in which (i) the bumper is disposed between the door and a door frame as the door is moved toward the closed position, and (ii) the base is offset from the door frame strike plate when the bumper is disposed between the door and the door frame.

In a further embodiment of this device, the base has a base width and the bumper has a bumper width, and the bumper width is greater than the base width. In one such example, each of the base and the bumper includes a compressible material, and, in the noise dampening configuration, the base is configured to be compressed against the door frame strike plate, and, in the safety configuration, the bumper is configured to be compressed against the door frame.

In a yet further embodiment of this device, in the noise dampening configuration, the base has a first base width when the base is in contact with the door frame strike plate when the door is at the closed position, and, in the safety configuration, the base has a second base width, different than the first base width, when the bumper is in contact with the door frame as the door is moved toward the closed position.

In a still further embodiment of this device, in the noise dampening configuration, the bumper has a first bumper width when the base is in contact with the door frame strike plate when the door is at the closed position, and, in the noise dampening configuration, the bumper has a second bumper width, different than the first bumper width, when the base is outside of a space between the face plate of the door and the door frame strike plate.

In another further embodiment of this device, each of the base and the bumper move with the door as the door is moved toward the closed position.

In a further embodiment of this device, the second orientation of the device is an inverse orientation of the first orientation of the device.

In a yet further embodiment of this device, the bumper comprises a coil-shaped member. In one such example, the base can include at least two layers of material, and the door face plate fixation structure of the base can include at least two base fixation apertures extending through the at least two layers of material. In a particular such example, the device can further include a rigid core disposed between the at least two layers of material of the base. This rigid core can include a first anchor arm and a second anchor arm, and the rigid core can extend from the base into the bumper such that the first anchor arm and the second anchor arm are located at the bumper. And, the rigid core can include at least two rigid core fixation apertures extending through the rigid core, and the at least two rigid core fixation apertures can be aligned, respectively, with the at least two base fixation apertures extending through the at least two layers of material.

In another further embodiment of this device, in the safety configuration, the bumper can be brought into contact with the door frame strike plate as the door is moved toward the closed position. And, in the noise dampening configuration, when the door is at the closed position, the bumper can be outside of a space between the face plate of the door and the door frame strike plate while the base is within the space between the face plate of the door and the door frame strike plate.

In a yet further embodiment of this device, in the safety configuration, the bumper can be disposed so as to prevent the door from moving into the closed position.

Another embodiment includes a method. This method embodiment includes the step of attaching a base of a multi-use door device to a face plate of a door in one of a noise dampening configuration and a safety configuration. This multi-use door device includes a bumper that extends out from the base. When the base is attached to the face plate of the door in the noise dampening configuration: (i) the base is disposed between the face plate of the door and a door frame strike plate when the door is at a closed position and (ii) the bumper is offset from the face plate of the door and the door frame strike plate when the door is at the closed position. And, when the base is attached to the face plate of the door in the safety configuration: (i) the bumper is disposed between the door and a door frame as the door is moved toward the closed position, and (ii) the base is offset from the door frame strike plate when the bumper is disposed between the door and the door frame. This method embodiment also includes the steps of removing the base of the multi-use door device from the face plate of the door, and, after removing the base, attaching the base of the multi-use door device to the face plate of the door in the other of the noise dampening configuration and the safety configuration.

In a further embodiment of this method, the method additionally includes the steps of, when the base is attached to the face plate of the door in the noise dampening configuration, compressing the base against the door frame strike plate, and, when the base is attached to the face plate of the door in the safety configuration, compressing the bumper against the door frame.

In a yet further embodiment of this method, the noise dampening configuration is an inverse orientation, relative to the safety configuration, of the multi-use door device attached to the face plate of the door.

In another embodiment of this method, in the safety configuration, the bumper is brought into contact with the door frame strike plate as the door is moved toward the closed position. And, in the noise dampening configuration, when the door is at the closed position, the bumper is outside of a space between the face plate of the door and the door frame strike plate while the base is within the space between the face plate of the door and the door frame strike plate.

In a further embodiment of this method, the bumper includes a coil-shaped member, and the base includes at least two layers of material.

The details of one or more examples are set forth in the accompanying drawings and the description below. Other features, objects, and advantages will be apparent from the description and drawings.

### BRIEF DESCRIPTION OF THE DRAWINGS

The following drawings are illustrative of particular embodiments of the present invention and therefore do not limit the scope of the invention. The drawings are intended for use in conjunction with the explanations in the following description. Embodiments of the invention will hereinafter be described in conjunction with the appended drawings, wherein like numerals denote like elements. The drawings are not necessarily to scale, though certain embodiments can include one or more components at the scale shown.

FIG. 1 is a perspective view of an embodiment of a multi-use door device.

FIGS. 2A and 2B show another embodiment of a multi-use door device that includes a rigid core. FIG. 2A is a perspective view of this embodiment of the multi-use door device with the rigid core shown in phantom lines for ease of visibility, and FIG. 2B is a cross-sectional view of this embodiment of the multi-use door device with the rigid core.

FIGS. 3A-3C show the multi-use door device attached to a door at a first orientation such that the device has a noise dampening configuration. FIG. 3A is a perspective view of the device attached to the door in the first orientation such that the device has a noise dampening configuration. FIG. 3B is a top plan view of the device attached to the door in the first orientation as the door is moved toward a closed position. And, FIG. 3C is a top plan view of the device attached to the door in the first orientation when the door is at the closed position against a door frame.

FIGS. 4A-4C show the multi-use door device attached to a door at a second orientation such that the device has a safety configuration. FIG. 4A is a perspective view of the device attached to the door in the second orientation such that the device has a safety configuration. FIG. 4B is a top plan view of the device attached to the door in the second orientation as the door is moved toward a closed position. And, FIG. 4C is a top plan view of the device attached to the door in the second orientation when a bumper of the device is brought into contact with a door frame as the door is moved toward the closed position against the door frame.

FIG. 5 is a flow diagram of an embodiment of a method of using a multi-use door device.

### DETAILED DESCRIPTION

The following detailed description is exemplary in nature and is not intended to limit the scope, applicability, or configuration of the invention in any way. Rather, the following description provides some practical illustrations for implementing embodiments of the present invention. Examples of constructions, materials, and/or dimensions are provided for selected elements. Those skilled in the art will recognize that many of the noted examples have a variety of suitable alternatives.

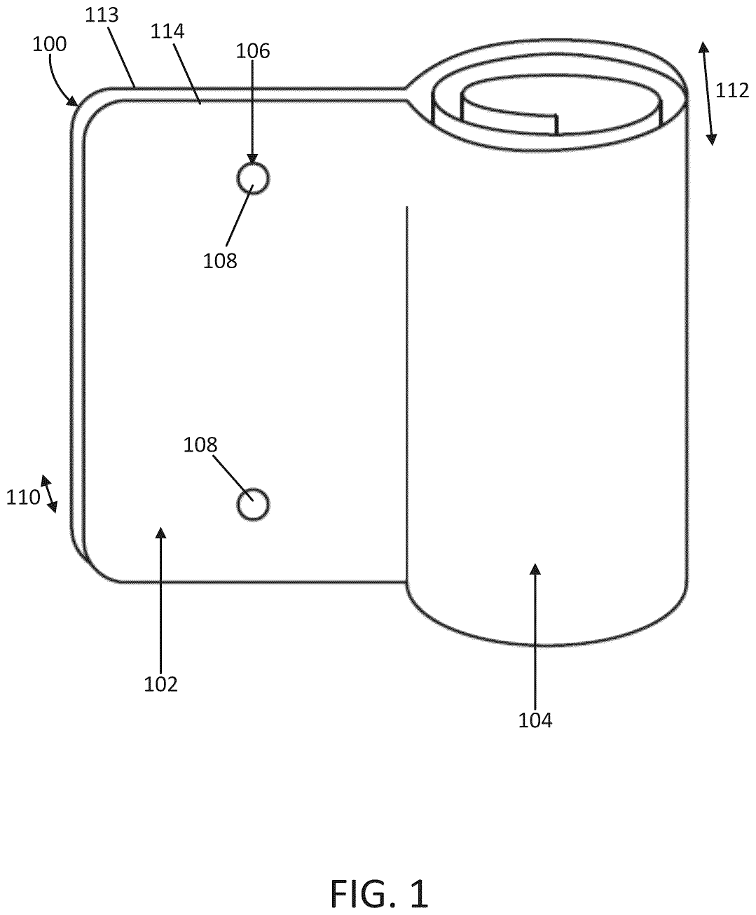

FIG. 1 shows a perspective view of an exemplary embodiment of a multi-use door device 100. The device 100 can include a base 102 and a bumper 104. The bumper 104 can extend out from the base 102. In the illustrated embodiment, the bumper 104 includes a coil-shaped member that extends out from the base 102. The base 102 can have a base width 110, and the bumper 104 can have a bumper width 112, where the base width 110 and the bumper width 112 are different. For example, for the illustrated embodiment of the device 100, the bumper width 112 is greater than the base width 110. Thus, in instances where the bumper 104 includes a coil-shaped member, such as in the embodiment shown here, the bumper width 112 can be a width of the coil-shaped member, and the width of the coil-shaped member can be greater than the base width 110.

The base 102 can include a feature for facilitating attachment of the device 100 to a door. In the illustrated embodiment, the base 102 includes a door plate fixation structure 106. The door plate fixation structure 106 can include any one or more structural mechanisms suitable for attaching the device 100 to a door, such as any one or more structural mechanisms suitable for attaching the device 100 to a door plate of the door. For example, as illustrated here, the door plate fixation structure 106 includes at least two base fixation apertures 108. The base fixation apertures 108 can each be configured to receive a fixation member, such as a screw, therethrough such that the fixation member extends through the respective base fixation aperture 108, through the door plate, and into the door thereby fixating the device 100 to the door via the door plate.

The device 100 can be made of one or more materials. In various embodiments, the device 100 can include a compressible material. For instance, each of the base 102 and the bumper 104 can include a compressible material, such as, for example, a type of felt material, synthetic fiber felt (e.g., made from recycled polymer material), or sheep's wool (e.g., from a sustainably farmed sheep). In some embodiments, such as that illustrated here, the device 100 can include at least two layers of material (e.g., at least two layers of compressible material). For example, the base 102 can include at least two layers of material—a first layer of material 113 (e.g., a first layer of compressible material) and a second layer of material 114 (e.g., a second layer of compressible material). In this example, the at least two base fixation apertures 108 can extend through each of the first layer of material 113 and the second layer of material 114 such that the at least two base fixation apertures 108 extend through the base width 110. In some such further examples, the bumper 104 can include at least two layers of material, for instance, where the bumper 104 includes each of the first layer of material 113 and the second layer of material 114. In one such instance, the coil-shaped member included at the bumper 104 can be made up of these at least two layers of material.

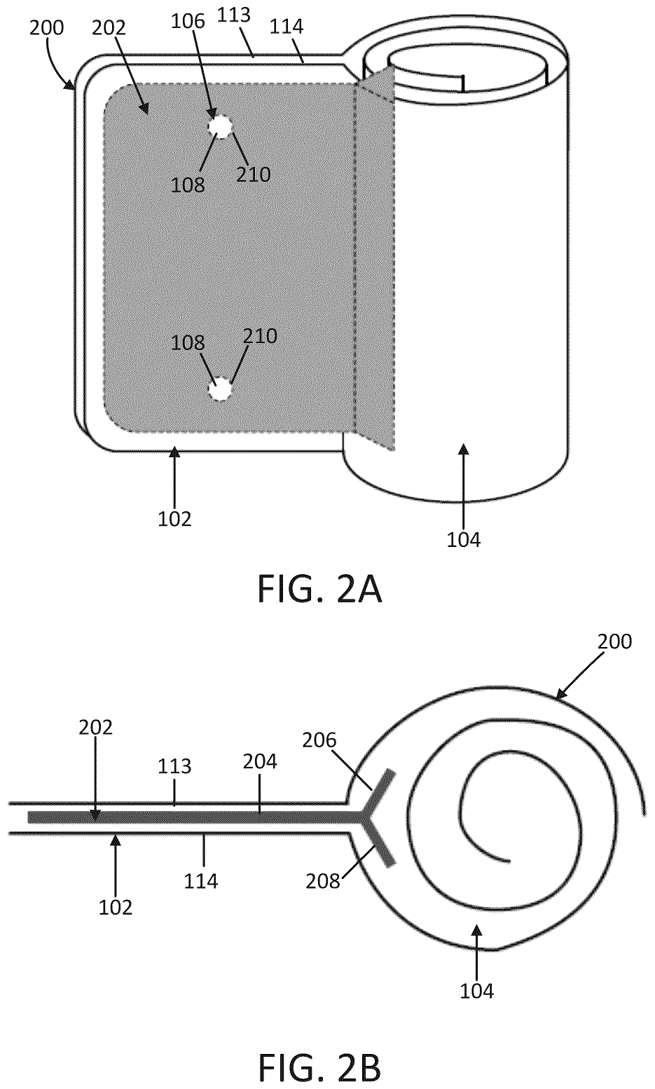

FIGS. 2A and 2B illustrate another embodiment of a multi-use door device 200 that includes a rigid core 202. FIG. 2A is a perspective view of this embodiment of the device 200 with the rigid core 202 shown in phantom lines for ease of visibility, and FIG. 2B is a cross-sectional view, taken radially through the device 200 as shown in FIG. 2A, of the device 200 with the rigid core 202. The device 200 can be similar to, or the same as, the device 100 described elsewhere herein except that the device 200 additionally includes the rigid core 202.

The device 200 can include the rigid core 202 disposed between the at least two layers of material 113, 114. The rigid core 202 can be made of a material with a flexural modulus that is greater than a flexural modulus of the at least two layers of material 113, 114, thus the presence of the rigid core 202 can help to increase the durability and operational life of the device 200. For example, the device 200 can include the rigid core 202 disposed between the at least two layers of material 113, 114 at the base 102 and/or at the bumper 104. In the illustrated embodiment, the rigid core 202 is included at each of the base 102 and the bumper 104. In particular, in the illustrated embodiment, the rigid core 202 is disposed between the at least two layers of material 113, 114 at the base 102 and between the at least two layers of material 113, 114 at the bumper 104.

The rigid core 202 can include a core base 204, a first anchor arm 206, a second anchor arm 208, and at least two rigid core fixation apertures 210. Each of the first anchor arm 206 and the second anchor arm 208 can extend out from the core base 204. For example, as illustrated in the example shown, the first anchor arm 206 can extend out from the core base 204 (e.g., at an acute angle relative to the core base 204) in a first direction and the second anchor arm 208 can extend out from the core base 204 (e.g., at an acute angle relative to the core base 204) in a second, different direction. In one example, such as that shown, the first anchor arm 206 and the second anchor arm 208 can extend out from the core base 204 at an acute angle of the same magnitude but in opposite directions from the core base 204 to from a type of “Y” shape. The rigid core 202 can extend from the base 102 into the bumper 104 such that the first anchor arm 206 and the second anchor arm 208 are located at the bumper 104. When the rigid core 202 is present, the at least two rigid core fixation apertures 210 can be used to help facilitate attachment of the device 200 to a door. Namely, the at least two rigid core fixation apertures 210 can extend though the rigid core 202, and the at least two rigid core fixation apertures 210 can be aligned, respectively, with the at least two base fixation apertures 108 that extend through the at least two layers of material 113, 114. As such, the base fixation apertures 108 along with the respective, associated the rigid core fixation apertures 210 can each be configured to receive a fixation member, such as a screw, therethrough such that the fixation member extends through the respective base fixation aperture 108 and associated rigid core fixation aperture 210, through the door plate, and into the door thereby fixating the device 200 to the door via the door plate.

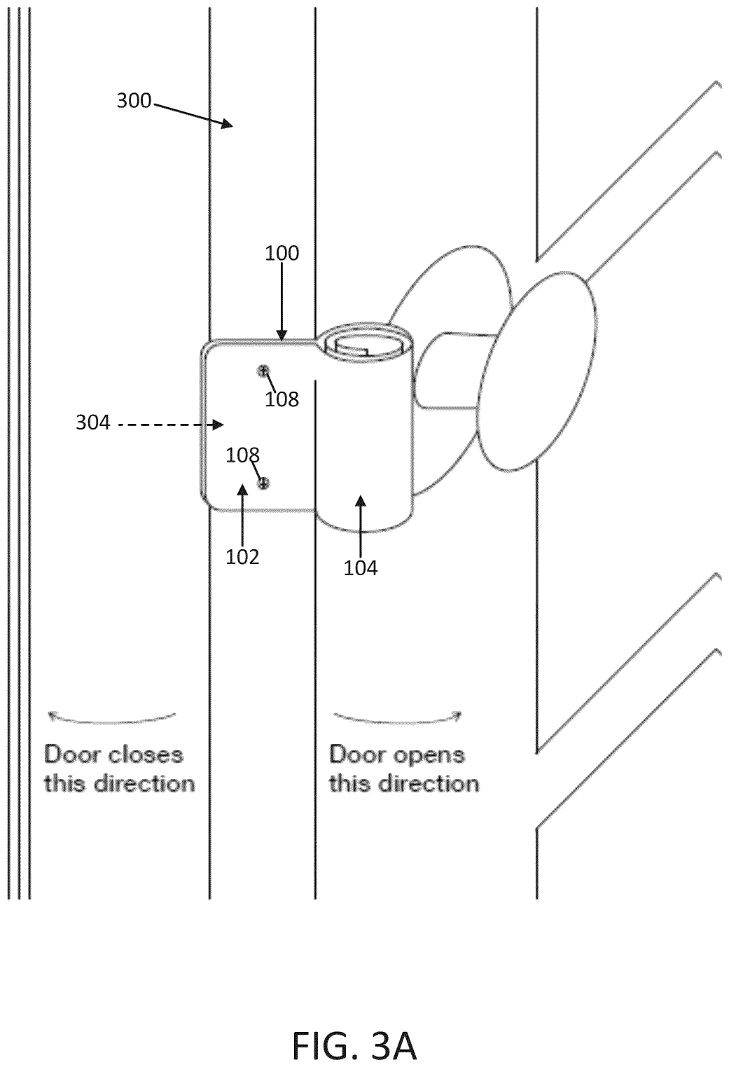

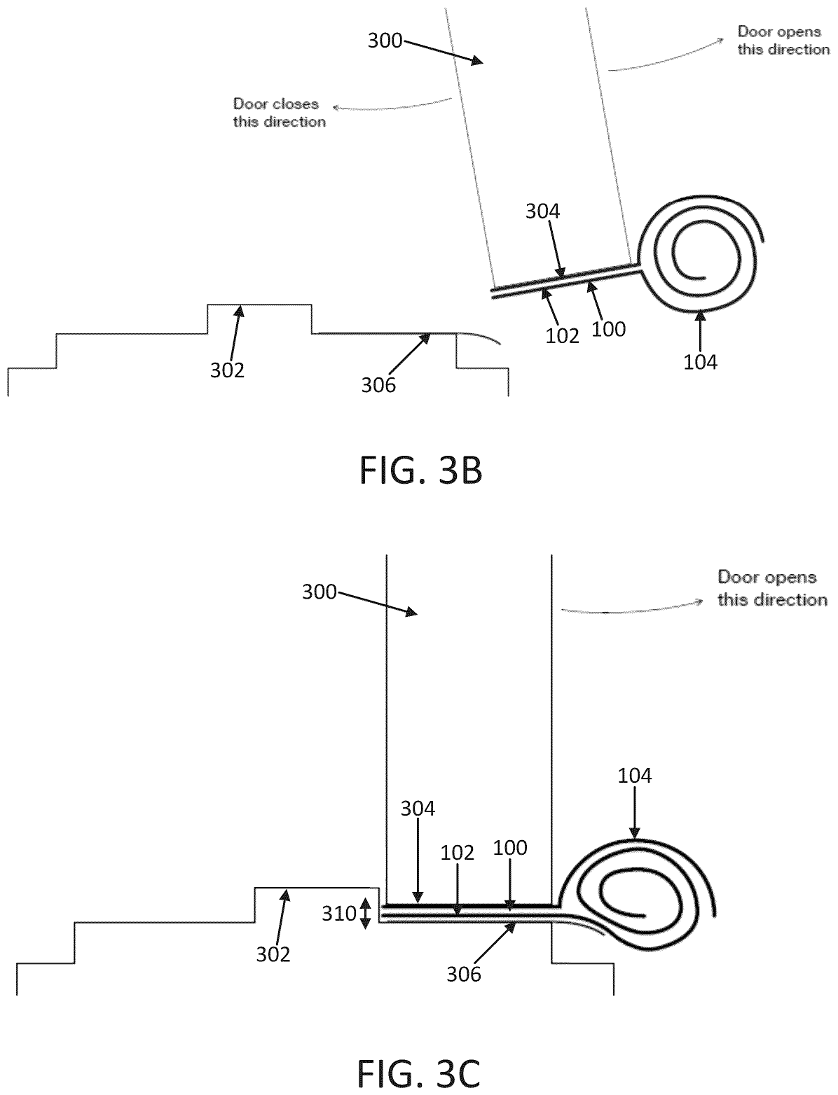

FIGS. 3A-3C illustrate the multi-use door device 100 attached to a door 300 at a first orientation such that the device 100 has a noise dampening configuration. While device 100 will be referenced here, the embodiment of the device 200 could instead be used and the following disclosure is intended to interchangeably and equally apply to either device 100, 200. FIG. 3A is a perspective view of the device 100 attached to the door 300 in the first orientation such that the device has a noise dampening configuration. FIG. 3B is a top plan view of the device 100 attached to the door 300 in the first orientation as the door 300 is moved toward a closed position. And, FIG. 3C is a top plan view of the device 100 attached to the door 300 in the first orientation when the door 300 is at the closed position against a door frame 302.

As noted, at the exemplary illustrations of FIGS. 3A-3C, the device 100 is attached to the door 300 in a first orientation that provides a noise dampening configuration of the device 100. In particular, the base 102 of the device 100 can be attached to a face plate 304 of the door 300 using fixation members (e.g., screw) inserted, respectively, through each base fixation member 108 and into a face plate aperture aligned with the respective base fixation member 108.

Because the device 100 is attached to the door 300, the device 100 can move with the door 300, as shown in the exemplary sequence illustrated by FIGS. 3B and 3C. Namely, as the door 300 is moved from an open position toward a closed position, the device 100 will move with the door 300 from the position shown at FIG. 3B to the closed position of the door 300 shown at FIG. 3C. Each of the base 102 and the bumper 104 of the device 100 move with the door 300 as the door 300 is moved, including as the door 300 is moved toward the closed position.

In the first orientation that provides a noise dampening configuration, as shown at FIGS. 3A-3C, the device 100 has the base 102 disposed between the face plate 304 of the door 300 and a door frame strike plate 306 when the door is at a closed position, such as the door's closed position shown at FIG. 3C. Thus, in the noise dampening configuration, the base 102 can be configured to be compressed against the door frame strike plate 306 when the door 300 is brought toward, and positioned at, the closed position. And, in the first orientation that provides a noise dampening configuration, the device 100 has the bumper 104 offset from the face plate 304 of the door 300 and the door frame strike plate 306 when the door is at the closed position, such as the door's closed position shown at FIG. 3C. Thus, in the noise dampening configuration, when the door 300 is at the closed position, such as that shown at FIG. 3C, the bumper 104 is outside of a space 310 between the face plate 304 of the door 300 and the door frame strike plate 306 while the base 102 is within the space 310 between the face plate 304 of the door 300 and the door frame strike plate 306.

As noted, in the noise dampening configuration, when the door 300 is closed, the base 102 can be compressed against the door frame strike plate 306. This can cause the base width 110 to reduce. For example, in the noise dampening configuration, the base 102 can have a first base width 110 when the base 102 is outside of the space 310 between the face plate 304 of the door 300 and the door frame strike plate 306, such as when the door 300 is open and when the door 300 is being moved toward the closed position as in FIG. 3B. Then, in the noise dampening configuration, the base 102 can have a second base width 110, which is less than the first base width 110, when the base 102 is compressed at the space 310 between the face plate 304 of the door 300 and the door frame strike plate 306, such as when the door 300 is at the closed position of FIG. 3C. Likewise, compression of the base 102 when the door 300 is closed can cause the width of the bumper 104 to change. For example, in the noise dampening configuration, the bumper 104 can have a first bumper width 112 when the base 102 is outside of the space 310 between the face plate 304 of the door 300 and the door frame strike plate 306, such as when the door 300 is open and when the door 300 is being moved toward the closed position as in FIG. 3B. Then, in the noise dampening configuration, the bumper 104 can have a second bumper width 112, different than the first bumper width, when the base 102 is in contact with the door frame strike plate 306 when the door 300 is at the closed position of FIG. 3C. This difference in bumper width 112 can be seen in comparing the default shape of the coil-shaped member at the bumper 104 at the exemplary time in the sequence at FIG. 3B when the door 300 has not yet closed and the deformed shape of the coil-shaped member at the bumper 104 at the exemplary time in the sequence at FIG. 3C when the door 300 is closed.

In the noise dampening configuration, the orientation and configuration of the device 100 can help to reduce or eliminate sound resulting from closing the door 300, yet while allowing the door 300 to be fully closed. For instance, the ability of the base 102 to be positioned at the space 310 between the face plate 304 of the door 300 and the door frame strike plate 306 when the door 300 is brought to the closed position can help to soften the impact of the door 300 against the door frame 302, and particularly help to soften the impact of the door 300 against the strike plate 306 of the door frame 302. Namely, the configuration of the base 102 to compress when moved into position between the face plate 304 of the door 300 and the door frame strike plate 306 when the door 300 is closed can act to absorb, and thereby dampen, force generated by contact between the face plate 304 of the door 300 and the door frame strike plate 306 which in turn can decrease sound output when the door 300 is closed. And, notably, the device 100, in the sound dampening configuration, can provide this sound reduction function while still allowing the door 300 to be fully closed at the door frame 302 and door frame strike plate 306, such as shown at FIG. 3C

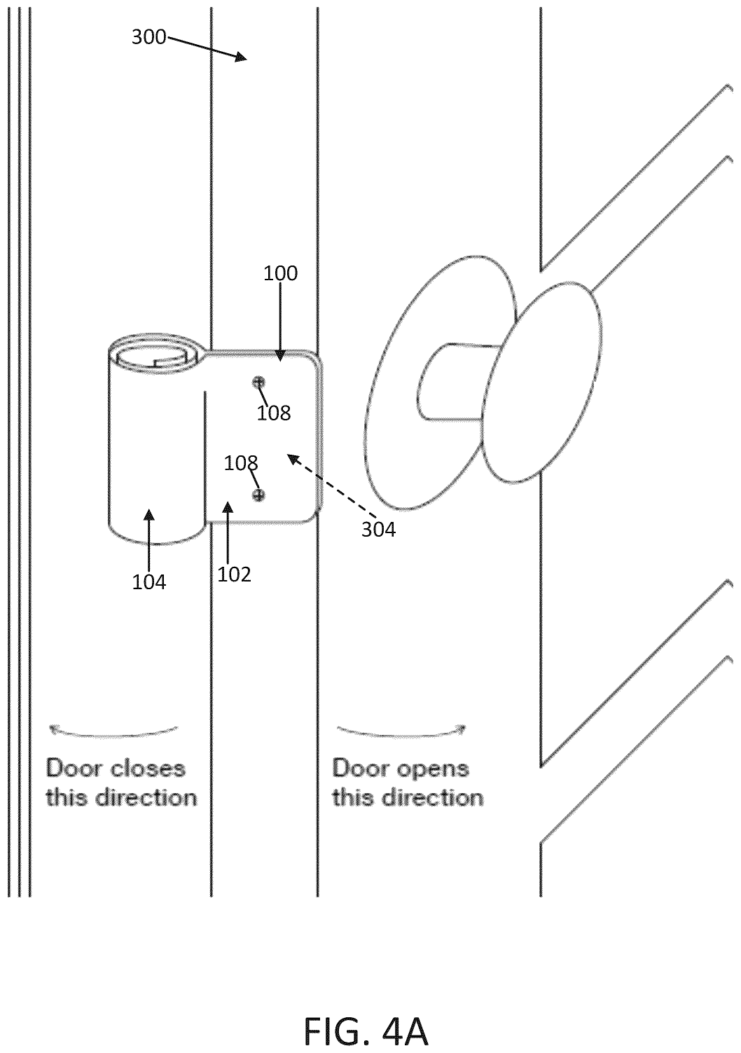

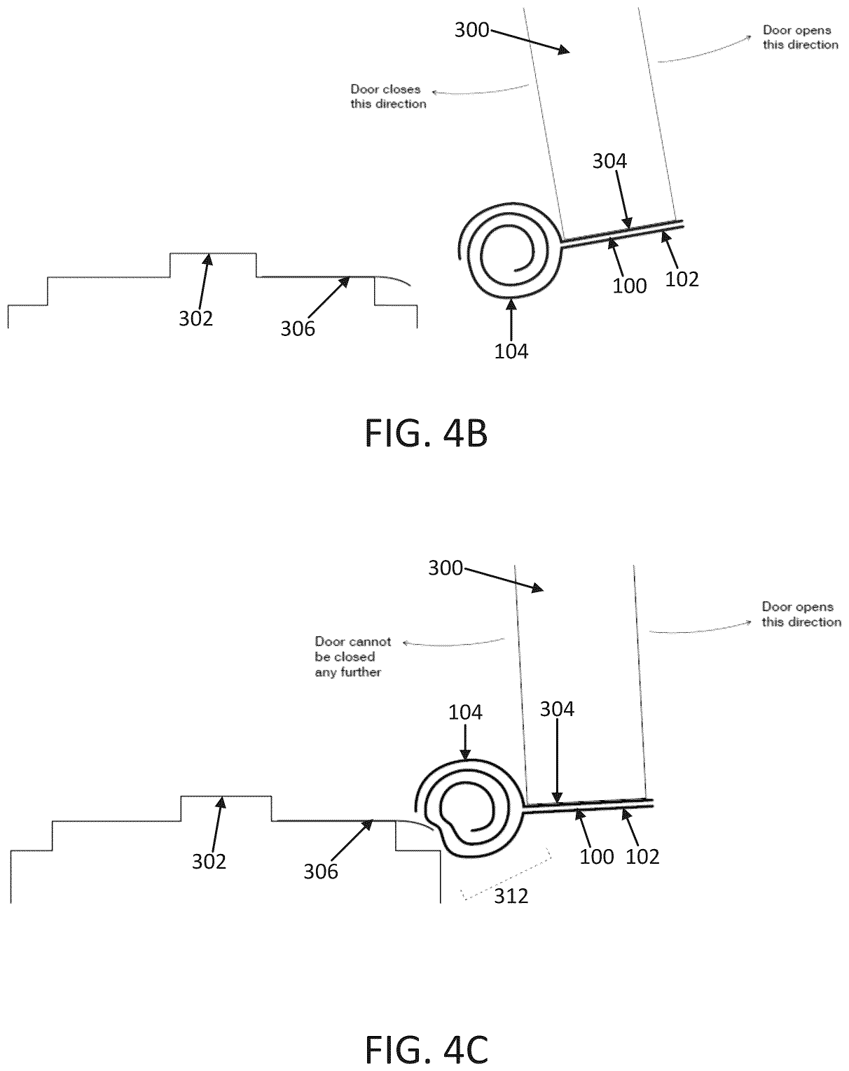

FIGS. 4A-4C show the multi-use door device 100 attached to the door 300 at a second orientation such that the device 100 has a safety configuration. FIG. 4A is a perspective view of the device 100 attached to the door 300 in the second orientation such that the device 100 has a safety configuration. FIG. 4B is a top plan view of the device 100 attached to the door 300 in the second orientation as the door 300 is moved toward the closed position. And, FIG. 4C is a top plan view of the device 100 attached to the door 300 in the second orientation when the bumper 104 of the device 100 is brought into contact with the door frame 302 as the door 300 is moved toward the closed position against the door frame 302.

As noted, at the exemplary illustrations of FIGS. 4A-4C, the device 100 is attached to the door 300 in the second orientation that provides the safety configuration of the device 100. In particular, the base 102 of the device 100 can be attached to the face plate 304 of the door 300 using fixation members (e.g., screw) inserted, respectively, through each base fixation member 108 and into a face plate aperture aligned with the respective base fixation member 108. For the illustrated embodiment, the second configuration at which the device 100 is attached to the door 300 to provide the safety configuration, as shown at example FIGS. 4A-4C, is an inverse, or mirror-image, orientation of the first orientation at which the device 100 is attached to the door 300 to provide the noise dampening configuration, shown at the example of FIGS. 3A-3C. In this way, transitioning the device 100 between the sound dampening configuration and the safety configuration can be done by simply removing the fixation members and rotating the device 100 one hundred and eight degrees relative to the door 300 and face plate 304 such that a surface of the base 102 that interfaced with the door 300 in the sound dampening configuration will now interface with the door frame 302 when in the safety configuration. Though in other embodiments the first and second orientations can be different orientations relative to one another.

In the second orientation that provides the safety configuration, as shown at FIGS. 4A-4C, the device 100 moves with the door 300. Namely, at FIG. 4B, as the door 300 begins to move toward the door frame 302, and thus toward the closed position, the bumper 104 serves as a leading surface of the device 100 as the door 300 is moved toward the closed position. Continued movement of the door 300 toward the closed position ultimately brings the bumper 104 into contact with the door frame 302, such as into contact with the door frame strike plate 306, at FIG. 4C.

In the second orientation that provides the safety configuration, as shown at FIGS. 4A-4C, the device 100 has the bumper 104 disposed between the door 300 and the door frame 302 as the door 300 is moved toward the closed position. Thus, in the safety configuration, the bumper 104 is disposed, and configured to be compressed against the door frame 302, so as to prevent the door 300 from moving into the closed position. This can cause the bumper 104 to take a deformed shape when in contact with the door frame 302 (E.g., in contact with the strike plate 306). As such, at FIG. 4C, a gap 312 is present between the door 300 and the door frame 302 (e.g., between the face plate 304 of the door 300 and the strike plate 306 of the door frame 302) given the bumper 104 is positioned at the door 300 in a manner to prevent the door 300 from being fully closed against the door frame 302. This gap 312 created by the described orientation of the bumper 104 can help to reduce instances of an object, such as one or more fingers, getting caught between the door 300 and the door frame 302 when the door 300 is shut (e.g., slammed shut quickly). Moreover, in embodiments where the bumper 104 include a compressible material, the bumper 104 can absorb force generated as a result of bringing the bumper 104 into contact with the door frame 302 (e.g., into contact with the door frame strike plate 306), thereby helping to reduce noise generated from this contact and helping to increase the robustness and useful life of the device 100. And, in the second orientation that provides the safety configuration, the device 100 has the base 102 offset from the door frame strike plate 306 when the bumper 104 is disposed between the door 300 and the door frame 302.

In comparing the noise dampening configuration to the safety configuration, the bumper 104 can be compressed and deformed in each of the noise dampening configuration to the safety configuration. And, in comparing the noise dampening configuration to the safety configuration, the base 102 can be compressed in the noise dampening configuration and but may remain in a somewhat constant state in the safety configuration. For example, in the noise dampening configuration, the base 102 can have a first base width 110 when the base 102 is in contact with the door frame strike plate 306 when the door 300 is at the closed position, and, in the safety configuration, the base 102 can have a second base width 110, different than the first base width, when the bumper 104 is in contact with the door frame 302 as the door 300 is moved toward the closed position. Thus, the base 102 can undergo more compression, and thus experience a greater reduction in the base width 110, when the device 100 is in the noise dampening configuration than when the device 100 is in the safety configuration.

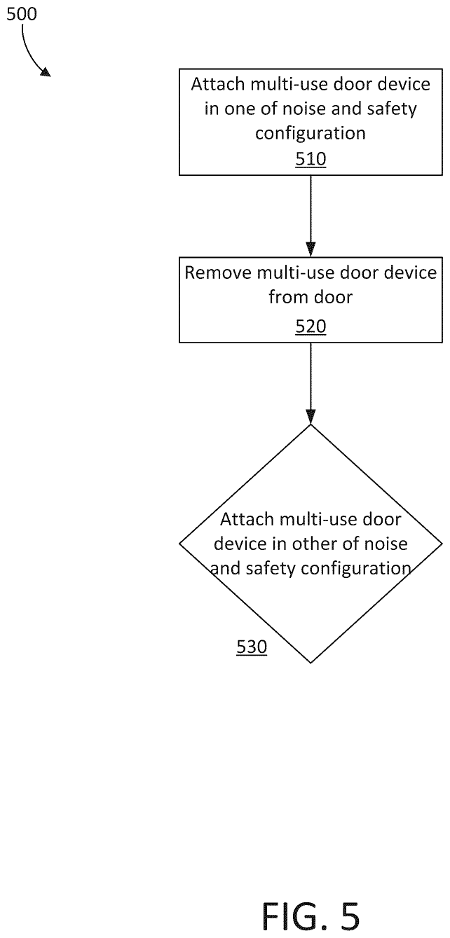

FIG. 5 is a flow diagram of an embodiment of a method 500 of using a multi-use door device. For example, the method 500 can be executed using a multi-use door device similar to, or the same as, those disclosed elsewhere herein. This can include executing the method 500 using the device 100 or the device 200 illustrated and disclosed previously herein.

At step 510, the method 500 includes attaching a base of a multi-use door device, to a door, in one of a noise dampening configuration and a safety configuration. For an embodiment of the multi-use door device, the bumper of the multi-use door device can include a coil-shaped member, and the base of the multi-use door device can include at least two layers of material (e.g., and, in a further embodiment of the multi-use door device, these at least two layers of material can also be included at the bumper of the multi-use door device, such as at the coil-shaped member of the bumper). As one example, the base can be attached to a face plate of the door in one of the noise dampening configuration and the safety configuration. The multi-use door device can include a bumper that extends out from the base. When the base is attached to the face plate of the door in the noise dampening configuration: (i) the base can be disposed between the face plate of the door and a door frame strike plate when the door is at a closed position and (ii) the bumper can be offset from the face plate of the door and the door frame strike plate when the door is at the closed position. And, when the base is attached to the face plate of the door in the safety configuration: (i) the bumper can be disposed between the door and a door frame as the door is moved toward the closed position, and (ii) the base can be offset from the door frame strike plate when the bumper is disposed between the door and the door frame.

At step 520, the method 500 includes removing the multi-use door device from the door. As one example, this can include removing one or more fixation members from the multi-use door device and the face plate of the door to allow the base of the multi-use door device to be detached from the face plate of the door.

At step 530, after removing the base from the door at step 520, the method 500 includes attaching the base of the multi-use door device to the door in the other of the noise dampening configuration and the safety configuration. As one example, this can include attaching the base of the multi-use door device to the face plate of the door in the other of the noise dampening configuration and the safety configuration as that used at step 510. Removing the base from the door and attaching the multi-use door device to the door in the other of the noise dampening configuration and the safety configuration can include reorienting the multi-use door device to be an inverse, or mirror-image, orientation of the first of the noise dampening configuration and the safety configuration attached at step 510.

In a further embodiment of the method 500, when the base of the multi-use door device is attached to the face plate of the door in the noise dampening configuration, the method 500 can include compressing the base against the door frame strike plate. And, in such embodiment, when the base of the multi-use door device is attached to the face plate of the door in the safety configuration, the method 500 can include compressing the bumper against the door frame.

In some embodiments of the method 500, the design of the multi-use door device can be such that the noise dampening configuration is an inverse orientation, relative to the safety configuration, of the multi-use door device attached to the face plate of the door. Accordingly, removing the multi-use door device from the face plate of the door at step 520 and attaching the multi-use door device to the face plate of the door in the other of the noise dampening configuration and the safety configuration can include rotating the multi-use door device one hundred and eighty degrees relative to the face plate of the door. Thus, the multi-use door device attached to the face plate of the door in one of the noise dampening configuration and the safety configuration can be a mirror image of the multi-use door device attached to the face plate of the door in the other of the noise dampening configuration and the safety configuration.

In carrying out the method 500, in certain embodiments, when the multi-use door device is in the safety configuration, the bumper of the multi-use door device can be brought into contact with the door frame strike plate as the door is moved toward the closed position. And, in such certain embodiments, when the multi-use door device is in the noise dampening configuration, when the door is at the closed position, the bumper of the multi-use door device can be outside of a space between the face plate of the door and the door frame strike plate while the base of the multi-use door device is within the space between the face plate of the door and the door frame strike plate.

Various non-limiting exemplary embodiments have been described. It will be appreciated that suitable alternatives are possible without departing from the scope of the examples described herein. These and other examples are within the scope of the following claims.

What is claimed is:

1. A device comprising:
a base that includes a door face plate fixation structure; and
a bumper that extends out from the base,
wherein, when the base is attached to a face plate of a door at a first orientation via the door face plate fixation structure, the device has a noise dampening configuration in which (i) the base is disposed between the face plate of the door and a door frame strike plate when the door is at a closed position and (ii) the bumper is offset from the face plate of the door and the door frame strike plate when the door is at the closed position, and
wherein, when the base is attached to the face plate of the door at a second orientation via the door face plate fixation structure, the device has a safety configuration in which (i) the bumper is disposed between the door and a door frame as the door is moved toward the closed position, and (ii) the base is offset from the door frame strike plate when the bumper is disposed between the door and the door frame.

2. The device of claim 1, wherein the base has a base width and the bumper has a bumper width, and wherein the bumper width is greater than the base width.

3. The device of claim 2, wherein each of the base and the bumper includes a compressible material, wherein, in the noise dampening configuration, the base is configured to be compressed against the door frame strike plate, and wherein, in the safety configuration, the bumper is configured to be compressed against the door frame.

4. The device of claim 1, wherein, in the noise dampening configuration, the base has a first base width when the base is in contact with the door frame strike plate when the door is at the closed position, and wherein, in the safety configuration, the base has a second base width, different than the first base width, when the bumper is in contact with the door frame as the door is moved toward the closed position.

5. The device of claim 1, wherein, in the noise dampening configuration, the bumper has a first bumper width when the base is in contact with the door frame strike plate when the door is at the closed position, and wherein, in the noise dampening configuration, the bumper has a second bumper width, different than the first bumper width, when the base is outside of a space between the face plate of the door and the door frame strike plate.

6. The device of claim 1, wherein each of the base and the bumper move with the door as the door is moved toward the closed position.

7. The device of claim 1, wherein the second orientation is an inverse orientation of the first orientation.

8. The device of claim 1, wherein the bumper comprises a coil-shaped member.

9. The device of claim 8, wherein the base comprises at least two layers of material, and wherein the door face plate fixation structure of the base comprises at least two base fixation apertures extending through the at least two layers of material.

10. The device of claim 9, wherein the device further comprises:
a rigid core disposed between the at least two layers of material of the base.

11. The device of claim 10, wherein the rigid core includes a first anchor arm and a second anchor arm, and wherein the rigid core extends from the base into the bumper such that the first anchor arm and the second anchor arm are located at the bumper.

12. The device of claim 11, wherein the rigid core comprises at least two rigid core fixation apertures extending through the rigid core, and wherein the at least two rigid core fixation apertures are aligned, respectively, with the at least two base fixation apertures extending through the at least two layers of material.

13. The device of claim 1, wherein in the safety configuration the bumper is brought into contact with the door frame strike plate as the door is moved toward the closed position.

14. The device of claim 13, wherein in the noise dampening configuration, when the door is at the closed position, the bumper is outside of a space between the face plate of the door and the door frame strike plate while the base is within the space between the face plate of the door and the door frame strike plate.

15. The device of claim 1, wherein in the safety configuration the bumper is disposed so as to prevent the door from moving into the closed position.

16. A method comprising the steps of:
attaching a base of a multi-use door device to a face plate of a door in one of a noise dampening configuration and a safety configuration, wherein the multi-use door device further comprises a bumper that extends out from the base, wherein when the base is attached to the face plate of the door in the noise dampening configuration: (i) the base is disposed between the face plate of the door and a door frame strike plate when the door is at a closed position and (ii) the bumper is offset from the face plate of the door and the door frame strike plate when the door is at the closed position, and wherein when the base is attached to the face plate of the door in the safety configuration: (i) the bumper is disposed between the door and a door frame as the door is moved toward the closed position, and (ii) the base is offset from the door frame strike plate when the bumper is disposed between the door and the door frame;
removing the base of the multi-use door device from the face plate of the door; and
after removing the base, attaching the base of the multi-use door device to the face plate of the door in the other of the noise dampening configuration and the safety configuration.

17. The method of claim 16, further comprising the steps of:
when the base is attached to the face plate of the door in the noise dampening configuration, compressing the base against the door frame strike plate; and
when the base is attached to the face plate of the door in the safety configuration, compressing the bumper against the door frame.

18. The method of claim 16, wherein the noise dampening configuration is an inverse orientation, relative to the safety configuration, of the multi-use door device attached to the face plate of the door.

19. The method of claim 16, wherein in the safety configuration the bumper is brought into contact with the door frame strike plate as the door is moved toward the closed position, and wherein in the noise dampening configuration, when the door is at the closed position, the bumper is outside of a space between the face plate of the door and the door frame strike plate while the base is within the space between the face plate of the door and the door frame strike plate.

20. The method of claim 16, wherein the bumper comprises a coil-shaped member, and wherein the base comprises at least two layers of material.
